(19) United States
(12) Patent Application Publication
(10) Pub. No.: US 2012/0075084 A1
(43) Pub. Date: Mar. 29, 2012

(54) SHORT-DISTANCE WIRELESS SIGNAL EXTENSION APPARATUS AND METHOD THEREOF

(75) Inventors: Yung-Chen Wang, Hsinchu County (TW); Jen-Tsung Wang, Tainan County (TW)

(73) Assignee: GEMTEK TECHNOLOGY CO., LTD., Hsinchu (TW)

(21) Appl. No.: 12/957,405

(22) Filed: Dec. 1, 2010

(30) Foreign Application Priority Data
Sep. 29, 2010 (TW) 99133076

(51) Int. Cl. G08C 19/12

(52) U.S. Cl. 340/13.25; 340/13.24

(57) ABSTRACT

A short-distance wireless signal extension method for extending the transmission range of a short-distance wireless remote control is provided. In the short-distance wireless signal extension method, a short-distance wireless signal is received. An n-times sampling is performed on the short-distance wireless signal to generate a sampled short-distance wireless signal, wherein n is a real number greater than or equal to 2. The sampled short-distance wireless signal is transmitted through a wireless transmission technique or a wired transmission technique.

### CROSS-REFERENCE TO RELATED APPLICATION

This application claims the priority benefit of Taiwan application serial no. 99133076, filed on Sep. 29, 2010. The entirety of the above-mentioned patent application is hereby incorporated by reference herein and made a part of this specification.

### BACKGROUND OF THE INVENTION

1. Field of the Invention

The present invention generally relates to a short-distance wireless remote control, and more particularly, to a short-distance wireless signal extension apparatus for extending the transmission range of a short-distance wireless remote control and a method thereof.

2. Description of Related Art

Many existing home appliances are controlled by using infrared (IR) remote controls. In particular, each device in a home theatre system is controlled by using a specific remote control. Generally speaking, the working distance of an IR remote control is usually not very long (usually within 10 meters). Besides, the radiation angle of an IR signal emitted by an IR remote control is within 30°-45°. Thus, if a controlled home appliance is placed too far away from an IR remote control or outside the radiation angle thereof, the IR remote control cannot control the home appliance successfully.

FIG. 1 is a diagram illustrating an IR remote control and a controlled CD player with a long distance in between. Referring to FIG. 1, the IR remote control system 1 includes an IR remote control 13, a CD player 12, and a TV set 11. The TV set 11 and the CD player 12 are connected with each other by using a video/audio transmission cable. As shown in FIG. 1, the IR remote control 13 and the CD player 12 are placed too far away from each other so that the CD player 12 cannot be controlled by using the IR remote control 13.

FIG. 2 is a diagram illustrating how the transmission distance of an IR remote control is extended by using an IR blaster. Referring to FIG. 2, the IR remote control system 2 includes an IR blaster 24, an IR remote control 23, a CD player 22, and a TV set 21. The TV set 21 and the CD player 22 are connected with each other by using a video/audio transmission cable. The IR blaster 24 receives an IR signal from the IR remote control 23 and relays the IR signal to the CD player 22, so that the transmission distance of the IR remote control 23 is extended and the problem of long distance between the IR remote control 23 and the CD player 22 is resolved.

FIG. 3 is a diagram illustrating a controlled CD player located outside the radiation angle of an IR remote control. Referring to FIG. 3, the IR remote control system 3 includes an IR remote control 33, a CD player 32, and a TV set 31. The TV set 31 and the CD player 32 are connected with each other by using a video/audio transmission cable. As shown in FIG. 3, the CD player 32 is placed outside the radiation angle of the IR remote control 33 therefore cannot be controlled by using the IR remote control 33.

FIG. 4 is a diagram illustrating how the radiation angle of an IR remote control is extended by using an IR blaster. Referring to FIG. 4, the IR remote control system 4 includes an IR blaster transmitter 45, an IR blaster receiver 44, an IR remote control 43, a CD player 42, and a TV set 41. The TV set 41 and the CD player 42 are connected with each other by using a video/audio transmission cable. The IR blaster receiver 44 receives an IR signal from the IR remote control 43 and decodes and demodulates the IR signal to obtain a control information, and the IR blaster receiver 44 sends the control information to the IR blaster transmitter 45 through a wireless transmission technique. The IR blaster transmitter 45 receives the wireless signal containing the control information and decodes and demodulates the wireless signal to obtain the control information. After that, the IR blaster transmitter 45 modulates and encrypts the control information to generate an IR signal for the CD player 42. Through the cooperation of the IR blaster transmitter 45 and the IR blaster receiver 44, the radiation angle of the IR remote control 43 is extended, and accordingly, the problem that the CD player 42 exceeds the radiation angle of the IR remote control 43 is resolved.

If the home appliance is placed too far away or behind an obstacle (for example, a wall or a decoration) therefore cannot receive signals properly, the IR blaster can transmit the IR signal emitted by the IR remote control to a farther place through a wireless transmission technique. However, an existing IR device can only relay an IR signal successfully by learning IR control codes in advance or by supporting a specific IR coding. In other words, a conventional IR blaster has to decode an IR signal and transmit the decoded control information to the other side through a wireless technique in order to extend the transmission range of the IR signal and control a home appliance.

If a conventional IR blaster only supports specific IR control codes, the IR blaster can only support a limited number of codes, and the patent right of a specific manufacturer may be violated and legal issue may be induced.

If a conventional IR blaster needs to learn IR control codes in advance, it requires a specific IR remote control. As a result, a user has to change his/her operation habit to use the IR remote control, which is very inconvenient. In addition, the additional IR remote control may confuse the user, and it is very inconvenient to the user if the additional IR remote control has to be used whenever a different home appliance is used.

### SUMMARY OF THE INVENTION

According to an embodiment of the present invention, a short-distance wireless signal extension method for extending the transmission range of a short-distance wireless remote control is provided. In the short-distance wireless signal extension method, a short-distance wireless signal is received. An n-times sampling is performed on the short-distance wireless signal to generate a sampled short-distance wireless signal, wherein n is greater than or equal to 2. The sampled short-distance wireless signal is transmitted through a wireless transmission technique or a wired transmission technique.

According to an embodiment of the present invention, a short-distance wireless signal extension method for extending the transmission range of a short-distance wireless remote control is provided. In the short-distance wireless signal extension method, a wired signal is received via a wired channel or a wireless signal is received via a wireless channel, and a sampled short-distance wireless signal containing a carrier is obtained from the wired signal or the wireless signal. The sampled short-distance wireless signal containing the carrier is restored to obtain a restored short-distance wireless signal. The restored short-distance wireless signal is sent to a controlled home appliance through a short-distance wireless transmission technique.

According to an embodiment of the present invention, a short-distance wireless signal extension receiver for extending the transmission range of a short-distance wireless remote control is provided. The short-distance wireless signal extension receiver includes a short-distance wireless signal receiving unit, a signal sampling unit, and a signal transmitting unit. The short-distance wireless signal receiving unit receives a short-distance wireless signal and directly supplies the short-distance wireless signal to the signal sampling unit without decoding or demodulating the short-distance wireless signal. The signal sampling unit performs an n-times sampling on the short-distance wireless signal to generate a sampled short-distance wireless signal, wherein n is greater than or equal to 2. The signal transmitting unit transmits the sampled short-distance wireless signal through a wireless transmission technique or a wired transmission technique.

According to an embodiment of the present invention, a short-distance wireless signal extension transmitter for extending the transmission range of a short-distance wireless remote control is provided. The short-distance wireless signal extension transmitter includes a signal receiving unit, a signal restoring unit, and a short-distance wireless signal transmitting unit. The signal receiving unit receives a wired signal via a wired channel or receives a wireless signal via a wireless channel, and the signal receiving unit obtains a sampled short-distance wireless signal from the wired signal or the wireless signal. The signal restoring unit restores the sampled short-distance wireless signal to obtain a restored short-distance wireless signal. The short-distance wireless signal transmitting unit directly sends the restored short-distance wireless signal to a controlled home appliance through a short-distance wireless transmission technique without decoding or demodulating the restored short-distance wireless signal.

As described above, embodiments of the present invention provide a short-distance wireless signal extension apparatus and a method thereof for extending the transmission range of a short-distance wireless remote control (i.e., for increasing the transmission distance and extending the radiation angle). By adopting the short-distance wireless signal extension apparatus and the method thereof provided by the present invention, a user needs not to change his/her operation habit or learn to use a new short-distance wireless remote control to operate a home appliance. Instead, the user can use an original short-distance wireless remote control to operate the home appliance. Additionally, the short-distance wireless signal extension apparatus and the method thereof do not decode or demodulate a received short-distance wireless signal, so that no other short-distance wireless signal encoding/decoding patent right will be violated.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating an infrared (IR) remote control and a controlled CD player with a long distance in between.

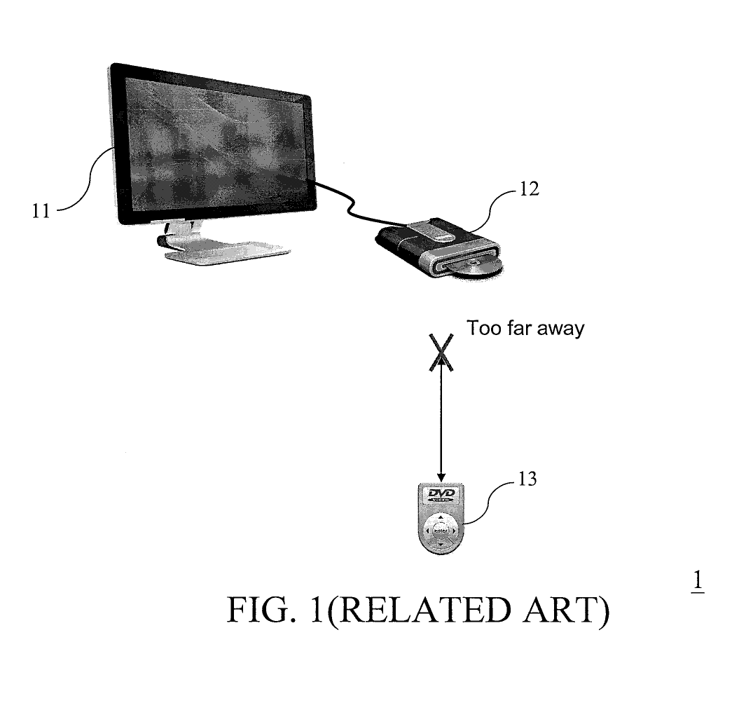

FIG. 2 is a diagram illustrating how the transmission distance of an IR remote control is extended by using an IR blaster.

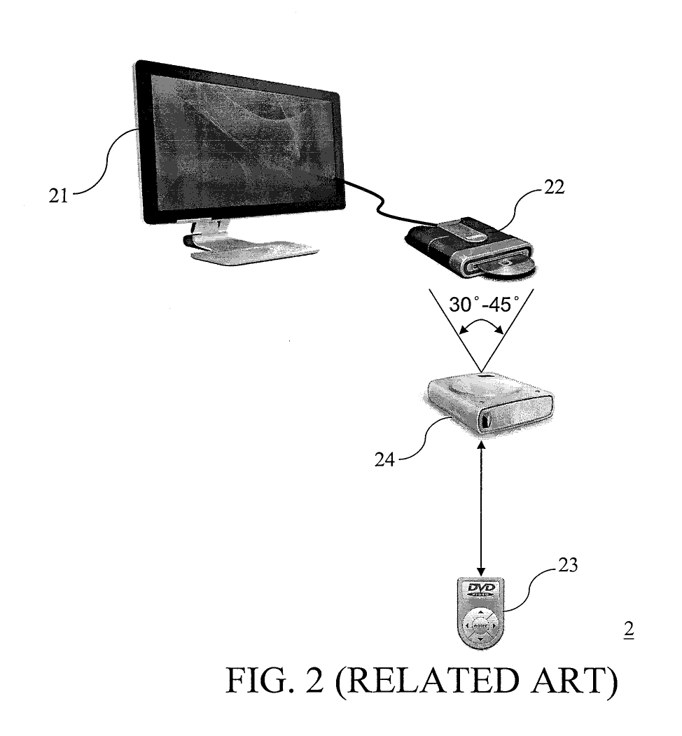

FIG. 3 is a diagram illustrating a controlled CD player located outside the radiation angle of an IR remote control.

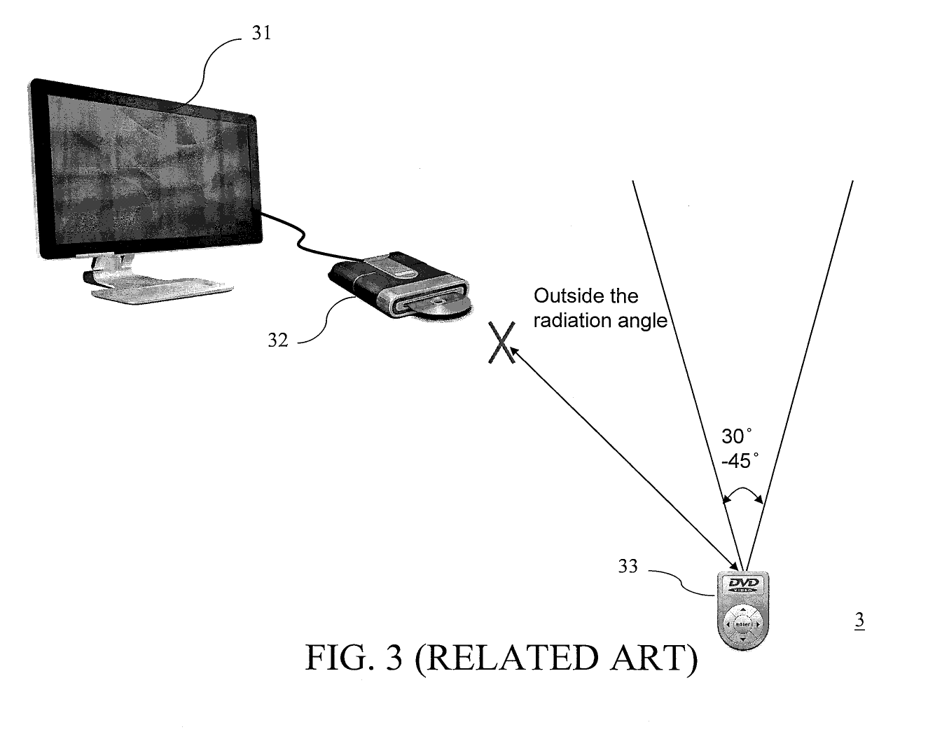

FIG. 4 is a diagram illustrating how the radiation angle of an IR remote control is extended by using an IR blaster.

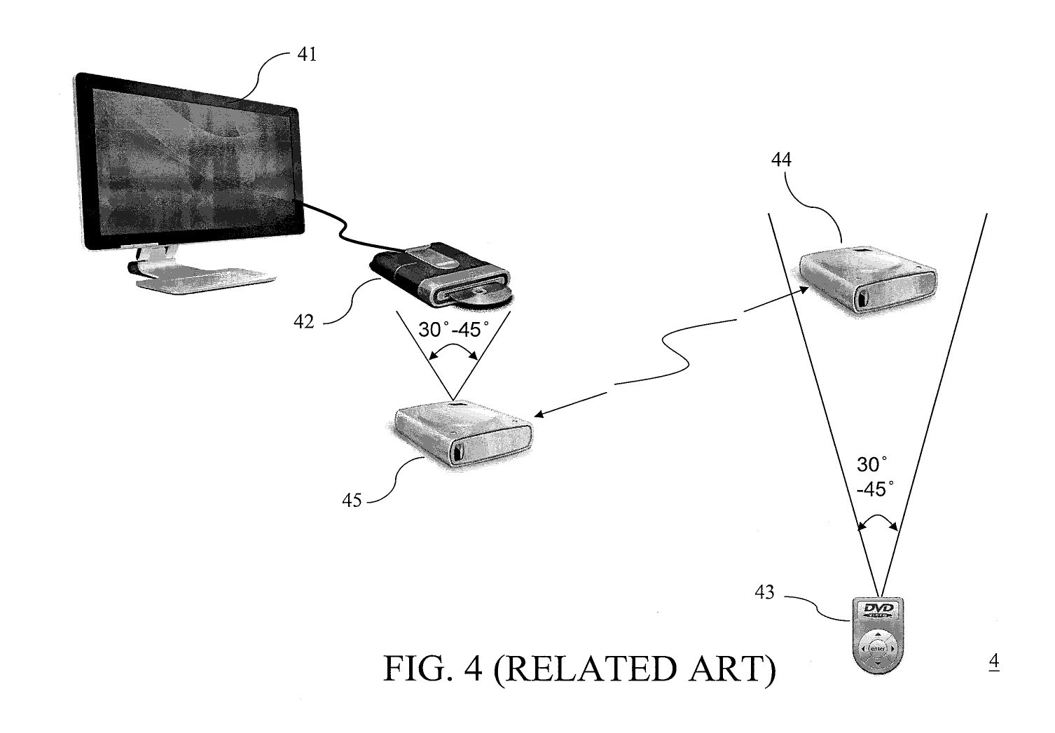

FIG. 5 is a signal sampling diagram of a short-distance wireless signal extension method according to an embodiment of the present invention.

FIG. 6 is a block diagram of a short-distance wireless signal extension apparatus according to an embodiment of the present invention.

FIG. 7 is a flowchart of a short-distance wireless signal extension method according to an embodiment of the present invention.

FIG. 8 is a flowchart of a short-distance wireless signal extension method according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

An embodiment of the present invention provides a short-distance wireless signal extension method, wherein a short-distance wireless signal extension apparatus is adopted for extending the transmission range of a short-distance wireless remote control. The short-distance wireless signal extension apparatus includes a receiver and a transmitter, wherein the receiver is placed close to the short-distance wireless remote control, and the transmitter is placed close to a home appliance. The short-distance wireless signal extension receiver close to the short-distance wireless remote control directly performs an n-times sampling (n is a real number greater than or equal to 2, and which may be an integer or a non-integer, such as 2.8 or 3) on a received short-distance wireless signal without decoding or demodulating the short-distance wireless signal, so as to generate a sampled short-distance wireless signal containing a carrier. Then, the short-distance wireless signal extension receiver generates a wireless signal through a wireless transmission technique (for example, a radio frequency (RF) wireless transmission technique) so as to send the sampled short-distance wireless signal to the corresponding short-distance wireless signal extension transmitter. The n-times sampling indicates that the sampling frequency is n times of the bandwidth of the carrier signal used by the short-distance wireless signal, and the bandwidth of the short-distance wireless signal is almost equal to the frequency of the carrier (of the short-distance wireless signal). In addition, if the frequency of the carrier is not limited to a specific frequency and the receiver using the short-distance wireless signal extension method supports a multi-frequency reception, the short-distance wireless signal is sampled by using n times of a maximum frequency among the multiple frequencies, so as to ensure that the short-distance wireless signal is losslessly sampled and restored.

It should be noted that the short-distance wireless signal in the present invention is a wireless signal with a low power and a short transmission distance, or may even be a wireless signal with restricted radiation angle, such as an infrared (IR) signal, a Bluetooth transmission signal, a far infrared (FIR) signal, or a near infrared (NIR signal). In addition, the wireless signal transmitted through the wireless transmission technique is a wireless signal having a higher power and a longer transmission distance compared to the short-distance wireless signal, or may even be a wireless signal with unrestricted radiation angle.

The short-distance wireless signal extension transmitter close to the home appliance receives the wireless signal and obtains a sampled short-distance wireless signal from the wireless signal, so as to obtain the original restored short-distance wireless signal (the restored short-distance wireless signal is equal to the short-distance wireless signal if there is no transmission or processing error). After restoring the sampled short-distance wireless signal, the short-distance wireless signal extension transmitter close to the home appliance directly transmits the restored short-distance wireless signal to the controlled home appliance through a short-distance wireless transmission technique.

It should be noted that in other applications, foregoing wireless transmission technique and wireless signal may be replaced by a wired transmission technique (for example, a home plug transmission technique) and a wired signal. Besides, the wired signal may be a home plug signal, and the wireless signal may be a RF signal, a wireless frequency hopping signal, or a wireless signal with a check sum.

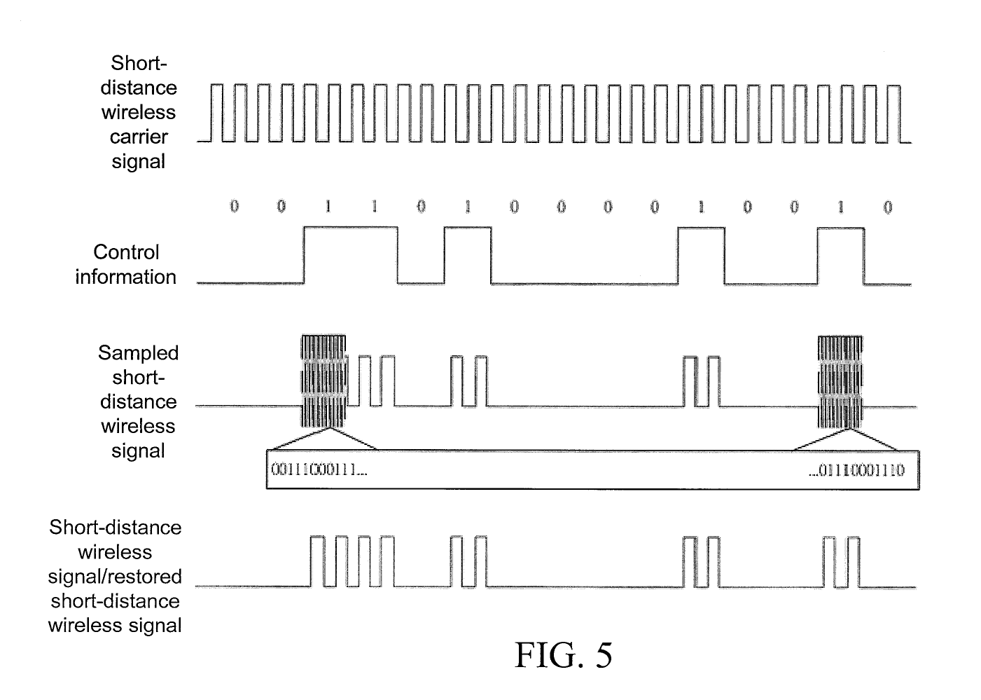

FIG. 5 is a signal sampling diagram of a short-distance wireless signal extension method according to an embodiment of the present invention. Referring to FIG. 5, the carrier is a 38 KHz short-distance wireless carrier signal, the control information is a digital signal composed of a plurality of “0” and a plurality of “1”, and the short-distance wireless signal transmitted by the short-distance wireless remote control is generated by modulating the short-distance wireless carrier signal according to the control information. An n-times sampling (n is any real number greater than or equal to 2, and in the present embodiment, n is 3) is performed on the short-distance wireless signal to generate a sampled short-distance wireless signal, wherein the sampled short-distance wireless signal may be a combination of a plurality of “0” and a plurality of “1”. The sampled short-distance wireless signal is obtained and restored by the short-distance wireless signal extension transmitter to generate a restored short-distance wireless signal. The restored short-distance wireless signal is equal to the short-distance wireless signal if there is no transmission or processing error.

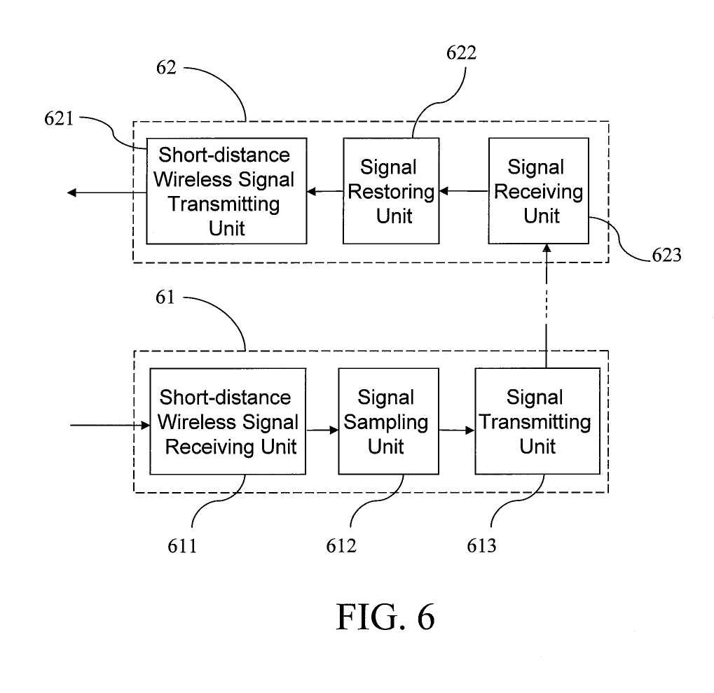

FIG. 6 is a block diagram of a receiver 61 and a transmitter 62 of a short-distance wireless signal extension apparatus according to an embodiment of the present invention. Referring to FIG. 6, the short-distance wireless signal extension receiver 61 close to the short-distance wireless remote control includes a short-distance wireless signal receiving unit 611, a signal sampling unit 612, and a signal transmitting unit 613 which are sequentially coupled together, and the short-distance wireless signal extension transmitter 62 close to the controlled home appliance includes a signal receiving unit 623, a signal restoring unit 622, and a short-distance wireless signal transmitting unit 621 which are sequentially coupled together.

The short-distance wireless signal receiving unit 611 receives a short-distance wireless signal from the short-distance wireless remote control and directly supplies the short-distance wireless signal to the signal sampling unit 612 without decoding or demodulating the short-distance wireless signal. The signal sampling unit 612 performs an n-times sampling on the short-distance wireless signal to generate a sampled short-distance wireless signal, wherein n is a real number greater than or equal to 2, such as 2.8 or 3. The signal transmitting unit 613 transmits the sampled short-distance wireless signal through a wireless transmission technique or a wired transmission technique. In other words, the signal transmitting unit 613 modulates and encodes the sampled short-distance wireless signal to generate a wireless signal or a wired signal and transmits the wireless signal or the wired signal to a wireless channel or a wired channel.

The wired transmission technique may be a power line transmission technique, and the wired signal may be a power line transmission signal. The wireless transmission technique may be a RF transmission technique, a wireless frequency hopping transmission technique, or a wireless transmission technique with a check sum, and the wireless signal may be a RF signal, a wireless frequency hopping signal, or a wireless signal with a check sum. In order to ensure the accuracy of the control information, the wireless transmission technique may be implemented as a wireless transmission technique with a check sum. In order to allow the wireless signal to be transmitted by using an optimal bandwidth, the wireless transmission technique may be implemented by using the wireless frequency hopping transmission technique.

The short-distance wireless signal extension transmitter 62 close to the controlled home appliance receives the wireless signal or the wired signal generated by the short-distance wireless signal extension receiver 61 close to the short-distance wireless remote control. Herein the signal receiving unit 623 receives the wired signal via a wired channel or receives the wireless signal via a wireless channel, and the signal receiving unit 623 obtains a sampled short-distance wireless signal from the wired signal or the wireless signal. In other words, the signal receiving unit 623 demodulates and decodes the wired signal or the wireless signal to obtain the sampled short-distance wireless signal. The signal restoring unit 622 restores the sampled short-distance wireless signal to obtain a restored short-distance wireless signal (the restored short-distance wireless signal is equal to the short-distance wireless signal if there is no transmission or processing error). The short-distance wireless signal transmitting unit 621 directly sends the restored short-distance wireless signal to the controlled home appliance (i.e., directly relays the restored short-distance wireless signal to the controlled home appliance) through a short-distance wireless transmission technique without decoding or demodulating the restored short-distance wireless signal.

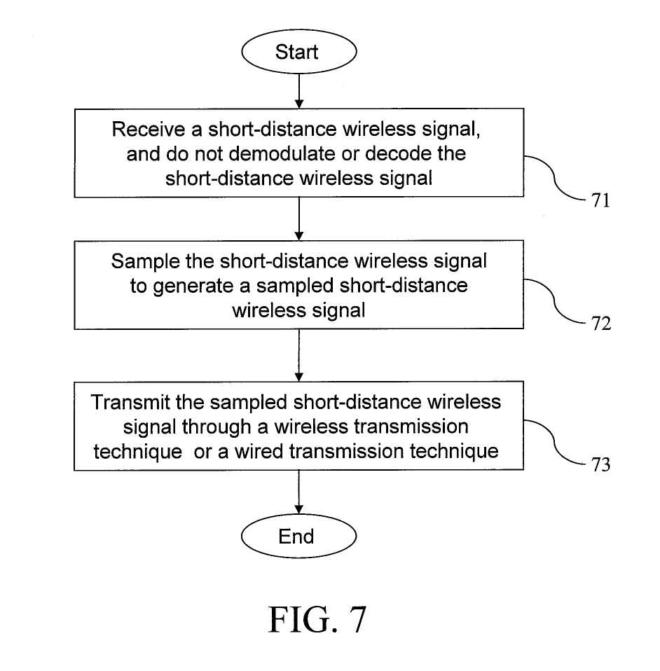

FIG. 7 is a flowchart of a short-distance wireless signal extension method executed by the short-distance wireless signal extension receiver 61 in the present embodiment. Referring to FIG. 7, in step 71, a short-distance wireless signal is received, and the short-distance wireless signal is not demodulated or decoded. In step 72, an n-times sampling is performed on the short-distance wireless signal to generate a sampled short-distance wireless signal. In step 73, the sampled short-distance wireless signal is transmitted through a wireless transmission technique or a wired transmission technique.

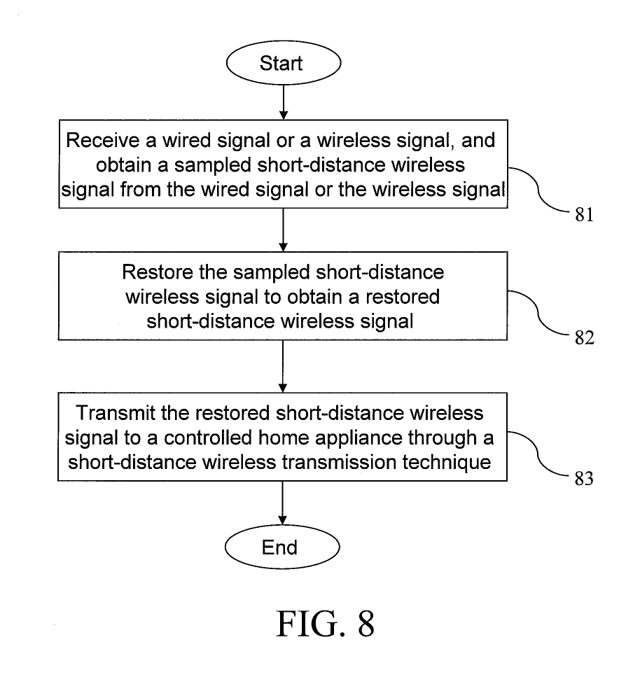

FIG. 8 is a flowchart of a short-distance wireless signal extension method executed by the short-distance wireless signal extension transmitter 62 in the present embodiment. Referring to FIG. 8, in step 81, a wired signal is received via a wired channel or a wireless signal is received via a wireless channel, and the sampled short-distance wireless signal is obtained from the wired signal or the wireless signal. In step 82, the sampled short-distance wireless signal is restored to obtain a restored short-distance wireless signal. In step 83, the restored short-distance wireless signal is transmitted to the controlled home appliance through a short-distance wireless transmission technique.

In summary, an embodiment of the present invention provides a short-distance wireless signal extension apparatus such that a user can use an original short-distance wireless remote control to control a home appliance without changing the user's operation habit. For example, if the user wants to control a CD player, the user needs not to learn to use a new short-distance wireless remote control. Instead, the user can use the original short-distance wireless remote control of the CD player and control the home appliance through the short-distance wireless signal extension apparatus provided by an embodiment of the present invention without changing the user's operation habit. In addition, because the short-distance wireless signal extension apparatus provided by an embodiment of the present invention does not encode or decode wireless signals, a developer needs not to worry about the violation of the short-distance wireless signal encoding/decoding patent right of a specific manufacturer or any related legal issue.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A short-distance wireless signal extension method, for extending a transmission range of a short-distance wireless remote control, the short-distance wireless signal extension method comprising:
receiving a short-distance wireless signal;
performing an n-times sampling on the short-distance wireless signal to generate a sampled short-distance wireless signal, wherein n is a real number greater than or equal to 2; and
transmitting the sampled short-distance wireless signal through a wireless transmission technique or a wired transmission technique.

2. The short-distance wireless signal extension method according to claim 1, wherein the short-distance wireless signal contains a carrier and the n-times sampling is directly performed on the short-distance wireless signal without decoding or demodulating the short-distance wireless signal.

3. The short-distance wireless signal extension method according to claim 2, wherein a frequency of the carrier is not limited to a specific frequency, and a receiver using the short-distance wireless signal extension method supports a reception of multiple frequencies and samples the short-distance wireless signal by using n times of a maximum frequency among the multiple frequencies, so as to ensure that the short-distance wireless signal is losslessly sampled and restored.

4. The short-distance wireless signal extension method according to claim 1, wherein the wired transmission technique is a power line transmission technique, and the wireless transmission technique is a radio frequency (RF) transmission technique, a wireless frequency hopping transmission technique, or a wireless transmission technique with a check sum.

5. The short-distance wireless signal extension method according to claim 1, wherein the short-distance wireless signal is generated by modulating a short-distance wireless carrier signal according to a control information.

6. A short-distance wireless signal extension method, for extending a transmission range of a short-distance wireless remote control, the short-distance wireless signal extension method comprising:
receiving a wired signal via a wired channel, or receiving a wireless signal via a wireless channel, and obtaining a sampled short-distance wireless signal from the wired signal or the wireless signal;
restoring the sampled short-distance wireless signal to obtain a restored short-distance wireless signal; and
sending the restored short-distance wireless signal to a controlled home appliance through a short-distance wireless transmission technique.

7. The short-distance wireless signal extension method according to claim 6, wherein the restored short-distance wireless signal is directly sent to the controlled home appliance through the short-distance wireless transmission technique without being decoded or demodulated.

8. The short-distance wireless signal extension method according to claim 6, wherein the wired signal is a power line transmission signal, and the wireless signal is a radio frequency (RF) signal, a wireless frequency hopping signal, or a wireless signal with a check sum.

9. The short-distance wireless signal extension method according to claim 6, wherein the restored short-distance wireless signal is generated by modulating a short-distance wireless carrier signal according to a control information.

10. A short-distance wireless signal extension receiver, for extending a transmission range of a short-distance wireless remote control, the short-distance wireless signal extension receiver comprising:
a short-distance wireless signal receiving unit, receiving a short-distance wireless signal and directly supplying the short-distance wireless signal without decoding or demodulating the short-distance wireless signal;
a signal sampling unit, performing an n-times sampling on the short-distance wireless signal to generate a sampled short-distance wireless signal, wherein n is a real number greater than or equal to 2; and
a signal transmitting unit, transmitting the sampled short-distance wireless signal through a wireless transmission technique or a wired transmission technique.

11. The short-distance wireless signal extension receiver according to claim 10, wherein the wired transmission technique is a power line transmission technique, and the wireless transmission technique is a radio frequency (RF) transmission technique, a wireless frequency hopping transmission technique, or a wireless transmission technique with a check sum.

12. The short-distance wireless signal extension receiver according to claim 10, wherein the short-distance wireless signal is generated by modulating a short-distance wireless carrier signal according to a control information.

13. A short-distance wireless signal extension transmitter, for extending a transmission range of a short-distance wireless remote control, the short-distance wireless signal extension transmitter comprising:
a signal receiving unit, receiving a wired signal via a wired channel or receiving a wireless signal via a wireless channel, and obtaining a sampled short-distance wireless signal from the wired signal or the wireless signal;
a signal restoring unit, restoring the sampled short-distance wireless signal to obtain a restored short-distance wireless signal; and
a short-distance wireless signal transmitting unit, directly sending the restored short-distance wireless signal to a controlled home appliance through a short-distance wireless transmission technique without decoding or demodulating the restored short-distance wireless signal.

14. The short-distance wireless signal extension transmitter according to claim 13, wherein the wired signal is a power line transmission signal, and the wireless signal is a radio frequency (RF) signal, a wireless frequency hopping signal, or a wireless signal with a check sum.

15. The short-distance wireless signal extension transmitter according to claim 13, wherein the restored short-distance wireless signal is generated by modulating a short-distance wireless carrier signal according to a control information.
